(19) United States
(12) Patent Application Publication
(10) Pub. No.: US 2023/0005274 A1
(43) Pub. Date: Jan. 5, 2023

(54) SECURITY SYSTEM AND MONITORING METHOD

(71) Applicant: DAIWA TSUSHIN CO., LTD, Ishikawa (JP)

(72) Inventor: Hidenari IWAMOTO, Kanazawa-shi, Ishikawa (JP)

(21) Appl. No.: 17/757,226

(22) PCT Filed: Mar. 26, 2020
(86) PCT No.: PCT/JP2020/013675

§ 371 Date: Jun. 12, 2022

(30) Foreign Application Priority Data
Dec. 13, 2019 (JP) 2019-225136

(51) Int. Cl. G06V 20/58; G06V 40/20; B60W 60/00

(52) U.S. Cl. CPC G06V 20/58; G06V 40/20; B60W 60/0015; B60W 2420/42

(57) ABSTRACT

A security system includes: an autonomous vehicle; a camera installed in the autonomous vehicle; and a crime determination unit that makes a determination regarding a crime on the basis of an image captured by the camera. The autonomous vehicle is a shared car shared by residents within a region; in response to a request, the autonomous vehicle automatically picks up at the departure point of the residents and automatically moves to the destination of the residents; and the camera take pictures of the moving section to the starting point and the moving section from the starting point to the destination; and the crime determination unit determines a crime based on the images taken in the moving section to the departure point and the moving section from the starting point to the destination.

The present application is a National Phase of International Application Number PCT/JP2020/013675, filed Mar. 26, 2020, and claims priority based on Japanese Patent Application No. 2019-225136, filed Dec. 13, 2019.

### TECHNICAL FIELD

The present invention relates to a security system and a monitoring method.

### BACKGROUND ART

For example, patent Literature 1 discloses an autonomous driving system includes an acquisitioner provided in each of a plurality of mobile objects and configured to acquire information about surroundings of the mobile object when the mobile object is moving; and a controller configured to determine a patrol plan for each of a plurality of regions on the basis of the information acquired by the acquisitioner of some mobile objects among the plurality of mobile objects that have moved in the same region; and create an operation command according to the patrol plan for each region determined by the controller.

### PATENT LITERATURE

[PTL 1] Japanese Unexamined Patent Application Publication No. JP2019-117574

### SUMMARY OF INVENTION

### Technical Problem

An objective of the present invention is to provide a security system that monitors by a patrol route that takes into account human behavior.

### Solution to Problem

The security system according to the present invention includes a plurality of autonomous vehicles; a camera installed in each of said plurality of autonomous vehicles; and a crime determination unit that determines a crime based on an image taken by the camera.

Preferably, the autonomous vehicle is a shared vehicle shared by residents in the area, and the crime determination unit determines a crime that may occur in the area.

Preferably, in response to a request from the residents, the autonomous vehicle automatically picks up at the departure point of the residents and automatically moves to the destination of the residents; and the camera take pictures of the moving section to the starting point and the moving section from the starting point to the destination; and the crime determination unit determines a crime based on the images taken in the moving section to the departure point and the moving section from the starting point to the destination.

Preferably, it also has a charger installed in a common facility in the area, the automatic vehicle is an electric vehicle, and while charging in the vicinity of the charger, waiting until requested by the residents, and after taking the residents to their destination, returns to the vicinity of the charger; and the camera shots from the timing of departure from the vicinity of the charger to the time of returning to the vicinity of the charger, according to the request of the residents; and the criminal determination unit makes a determination regarding the crime based on the images taken from the vicinity of the charger to the return to the vicinity of the charger.

Further, in the monitoring method according to the present invention, the step of moving the autonomous vehicle shared by the residents at the request of the residents; and the step of photographing the outside of the vehicle by the camera installed in the autonomous vehicle; and the step of making a determination regarding a crime based on the image taken by the computer.

### Advantageous Effects of Invention

It is possible to perform monitoring by a patrol route that takes into account human behavior.

### BRIEF DESCRIPTION OF DRAWINGS

FIG. 1 is a drawing illustrating the whole structure of the security system 1.

FIG. 2 is a schematic diagram explaining the monitoring area in the security system 1.

FIG. 3 is a drawing illustrating the hardware configuration of management server 2.

FIG. 4 is a drawing mainly illustrating the part related to information processing in the hardware configuration of the autonomous vehicle 3.

FIG. 5 is a drawing illustrating the functional structure of the management server 2 and the autonomous vehicle 3.

FIG. 6 is a flowchart explaining the monitoring process (S10) by a security system 1.

### DESCRIPTION OF EMBODIMENTS

Hereinafter, embodiments of the present invention are described while referencing the drawings.

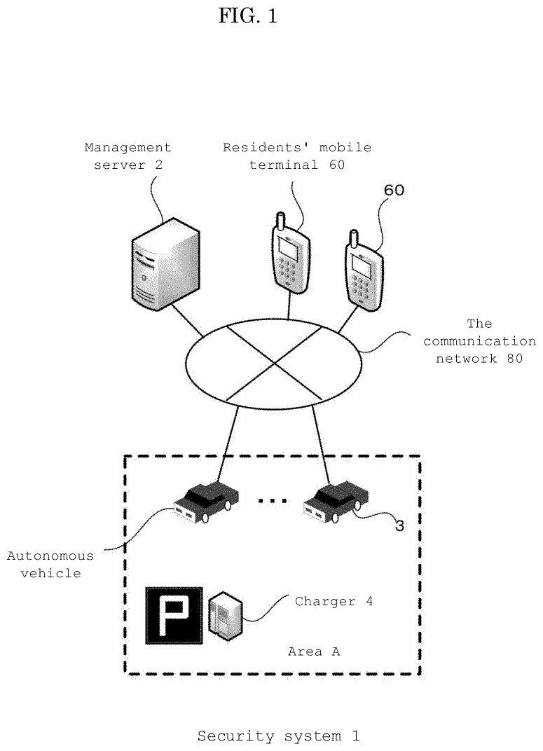

FIG. 1 is a drawing illustrating the whole structure of the security system 1.

As illustrated in FIG. 1, the security system 1 includes a management server 2 that manages the degree of danger in the area, an autonomous vehicle 3 that moves by automatic driving, a charger 4 provided at the departure/arrival point of the autonomous vehicle 3, and a mobile terminal 60 used by residents in the area. And these configurations are connected to each other via a communication network 80 such as a wireless public line.

The management server 2 is an example of the crime determination unit according to the present invention, and is a computer terminal on which the monitoring program 22 is installed. The management server 2 of this example determines the possibility of a crime based on an image taken by a camera 308 installed in the autonomous vehicle 3.

The autonomous vehicle 3 is a level 3 or higher vehicle car that moves by self-driving. For example, the autonomous vehicle 3 is a level 5 electric vehicle that realizes fully automatic driving. The autonomous vehicle of this example is a self-driving electric vehicle (share car) shared by local residents. The autonomous vehicle 3 may configured takes a picture of the face of the occupant, authenticates the face of the local resident based on the taken image, and moves to the destination of the resident only when the face recognition is successful.

The charger 4 is a charger for charging the battery built in the autonomous vehicle 3, for example, it is installed in a common facility in the area. The charger 4 of this example is installed in the parking lot of a public hall. The charger 4 may configure to automatically start charging when the autonomous vehicle comes to a predetermined area (near area). The mobile terminal 60 is, for example, a smart phone used by local residents, and an application for using the autonomous vehicle 3 is installed. The communication network 80 is, for example, an Internet network including a wireless public line and a wireless LAN.

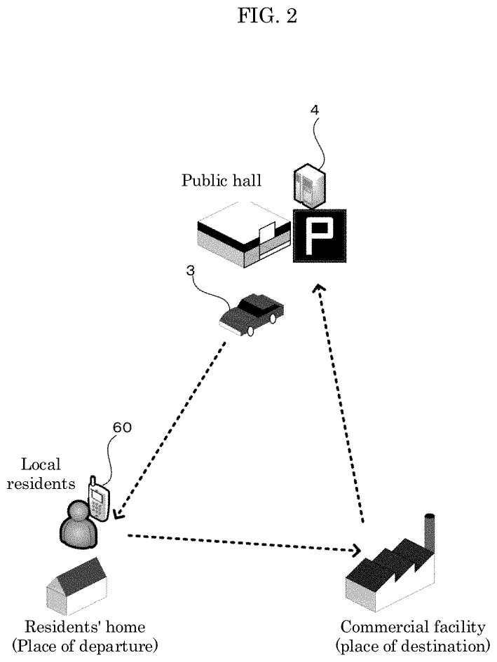

FIG. 2 is a schematic diagram explaining the monitoring area in the security system 1.

As shown in FIG. 2, the automatic vehicle 3 departs from the charger 4 of the public hall and picks up the residents to the departure place of the residents in response to the vehicle allocation request from the residents' mobile terminal 60. After getting on the requested residents, move to the destination of the residents, get off the residents, and then return to the charger 4 of the public hall. During these movements, the camera 308 of the autonomous vehicle 3 photographs the surroundings, and the management server 2 determines the possibility of a crime based on the captured images.

That is, in the security system 1, the route (the starting point and the destination designated by the residents) that takes into account the behavior of the residents is monitored. Furthermore, by starting from the common facilities in the area such as public halls, the common facilities in the area can be monitored intensively. In addition, the frequency of surveillance patrols depends on the frequency of outings of residents. For example, when crimes are likely to occur, such as local festivals and fireworks displays, surveillance patrols can be focused on.

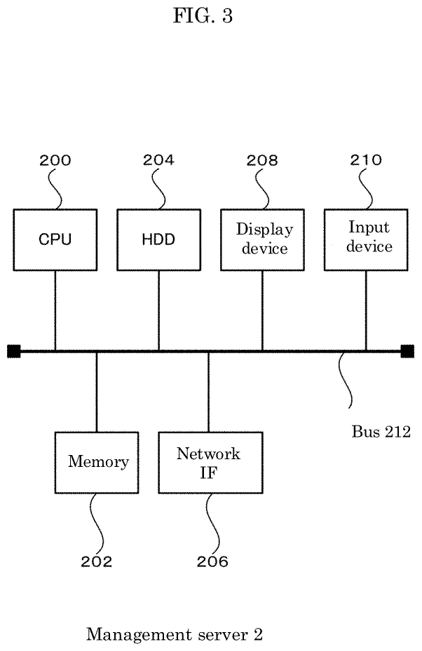

FIG. 3 is a drawing illustrating the hardware configuration of management server 2.

As shown in FIG. 3, the management server 2 includes a CPU 200, a memory 202, an HDD 204, a network interface 206 (network IF206), a display device 208, and an input device 210, which are interconnected via a bus 212.

The CPU 200 is, for example a central processing unit.

The memory 202 is, for example, a volatile memory and functions as a main storage device.

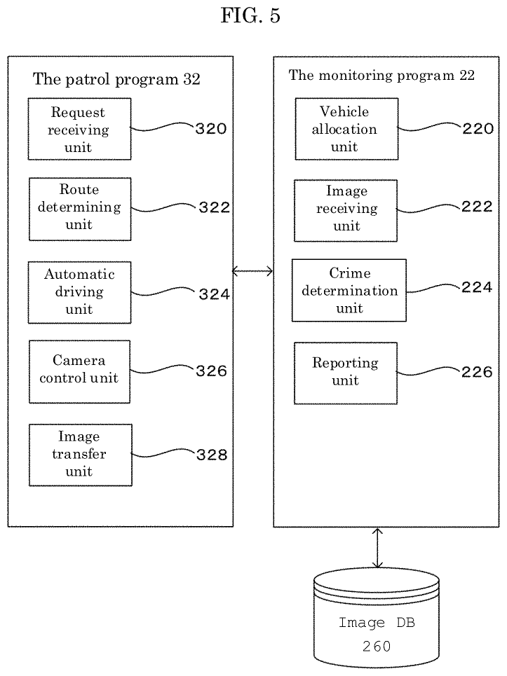

The HDD 204 is, for example, a hard disk drive and functions as a nonvolatile storage device configured to store a computer program (for example, the monitoring program 22 in FIG. 5) and other data files (for example, image data taken in the past).

The network IF 206 is an interface for wired or wireless communication. For example, the network IF 206 enables communication on the autonomous vehicle 3.

The display device 208 is, for example, a liquid crystal display.

The input device 210 is, for example, a keyboard and a mouse.

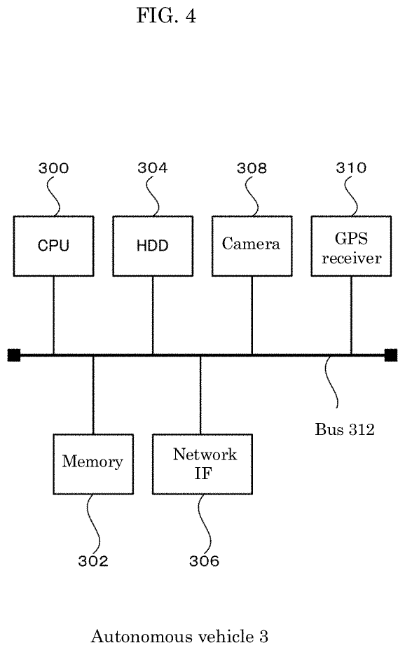

FIG. 4 is a drawing mainly illustrating the part related to information processing in the hardware configuration of the autonomous vehicle 3. In addition to the configuration illustrated in FIG. 4, the autonomous vehicle 3 includes a hardware configuration for functioning as a self-driving electric vehicle.

As shown in FIG. 4, the autonomous vehicle 3 includes a CPU 300, a memory 302, an HDD 304, a network interface 306 (network IF 306), a camera 308, and a GPS receiver 310, which are interconnected via a bus 312.

The CPU 300 is, for example, a central processing unit.

The memory 302 is, for example, a volatile memory and functions as a main storage device.

The HDD 304 is, for example, a hard disk drive and functions as a nonvolatile storage device configured to store a computer program (for example, the monitoring program 22 in FIG. 5) and other data files.

The network IF 306 is an interface for wired or wireless communication. For example, the network IF 206 enables communication on the management server 2.

The camera 308 is a camera that photographs the surroundings of the autonomous vehicle 3, for example, a camera built in a drive recorder.

The GPS receiver 310 is an example of a position characteristic device that identifies the position of the autonomous vehicle 3, for example, a GPS receiver provided in a car navigation system.

FIG. 5 is a drawing illustrating the functional structure of the management server 2 and the autonomous vehicle 3.

As illustrated in FIG. 5, the monitoring program is installed on the management server 2, and the image database 260 (image DB 260) is configured.

In addition, the patrol program 32 is installed in the autonomous vehicle 3.

The monitoring program 22 has a vehicle allocation unit 220, an image receiving unit 222, a crime determination unit 224, and a reporting unit 226.

The patrol program 32 includes a request receiving unit 320, a route determining unit 322, an automatic driving unit 324, a camera control unit 326, and an image transfer unit 328.

Note that part or all of the monitoring program and the patrol program 32 may be realized by hardware such as an ASIC, or may be realized by borrowing a part of the functions of the OS (Operating System).

In the patrol program 32, the request receiving unit 320 receives a request for vehicle allocation from the residents via the management server 2. For example, the request receiving unit 320 receives the location information of the departure place of the resident and the location information of the destination of the resident as a vehicle allocation request from the mobile terminal 60. The location information of the resident's destination can be sequentially added even after the resident gets on the autonomous vehicle 3.

The route determination unit 322 determines the movement route of the autonomous vehicle 3 based on the vehicle allocation request received by the request reception unit 320. For example, the route determination unit 322 determines a route from the current location to the departure point of the resident, a route from the departure point of the resident to the destination of the resident, and a route from the destination of the resident to the charger 4. The route determination unit 322 changes the route according to the added or changed destination of the resident when the destination of the resident is added or changed by the request receiving unit 320.

The automatic driving unit 324 automatically drives the automatic vehicle 3 on the route determined by the route determining unit 322. When the automatic driving unit 324 starts the automatic driving of the automatic vehicle 3, the camera control unit 326 controls the camera 308 to start photographing the surroundings; and when the automatic vehicle 3 returns to the vicinity of the charger 4 and the automatic driving unit 324 finishes the automatic driving, the shooting by the camera 308 is finished.

The image transfer unit 328 sequentially transmits the image data of the image taken by the camera 308 and the position information indicating the place where the image was taken to the management server 2. For example, the image transfer unit 328 immediately transmits the image data of the image taken by the camera 308 and the position information of the shooting location to the management server 2.

The monitoring program 22, determines the automatic vehicle 3 to be assigned from the automatic vehicles 3 waiting in the vicinity of the charger 4, when the vehicle allocation unit 220 receives a vehicle allocation request from the local residents; and transmit a vehicle allocation request (including location information of the departure place) to the autonomous vehicle 3. For example, when the vehicle allocation unit 220 receives a vehicle allocation request from the resident's mobile terminal 60, the vehicle allocation unit 220 determines the autonomous vehicle 3 to be assigned based on the charging status, from among the autonomous vehicles 3 waiting in the vicinity of the charger 4.

The image receiving unit 222 receives the image data of the image taken by the camera 308 of the autonomous vehicle 3 and the position information of the photographing location from the autonomous vehicle 3. The image receiving unit 222 of this example receives the image data of the captured image and the position information of the photographing location in real time from the autonomous vehicle 3.

The crime determination unit 224 makes a determination regarding a crime based on the image data received by the image reception unit 222. The determination regarding a crime is, for example, determination of the presence or absence of a crime, calculation of a crime occurrence probability, or the like. For example, the crime determination unit 224 compares the received image data with the image data taken at the same place in the past based on the image data and the position information of the shooting place received by the image receiving unit 222; and calculates the probability of occurrence. The crime determination unit 224 of this example calculates the probability of crime occurrence by deep learning based on the image data taken, the position information of the shooting place, and the shooting time.

The reporting unit 226 reports on the occurrence of a crime based on the determination result by the crime determination unit 224. For example, when the probability of crime occurrence calculated by the crime judgment unit 224 is equal to or higher than the reference value, the reporting unit 226 obtains the calculated crime occurrence probability and the location information of the shooting location; and informs the police, the security company, or the public hall etc.

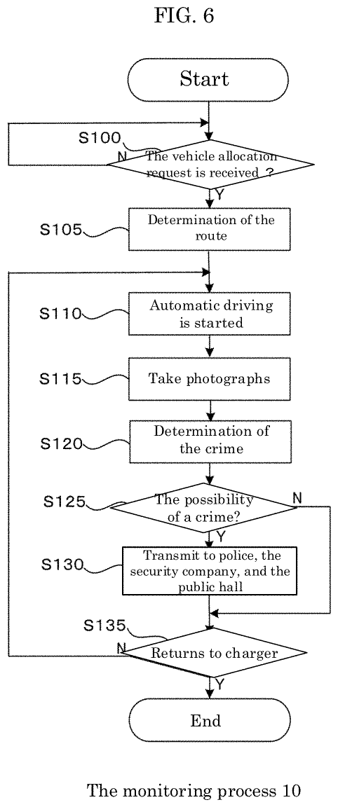

FIG. 6 is a flowchart explaining the monitoring process (S10) by a security system 1. As illustrated in FIG. 6, in step 100 (S100), the management server 2 waits until the vehicle allocation request is received from the resident's mobile terminal 60 (S100: No), and move to S105 processing when the vehicle allocation request is received (S100: Yes).

In step 105 (S105), the vehicle allocation unit 220 of the management server 2 compares the charging states of the autonomous vehicle 3, selects the autonomous vehicle 3 having a larger remaining charge; and transmits to the selected autonomous vehicle 3, the location information of the resident's departure place and the location information of the resident's destination.

When the request receiving unit 320 of the selected autonomous vehicle 3 receives the request from the vehicle allocation unit 220, it outputs the received position information of the departure place and the destination to the route determination unit 322 and instructs the route determination.

The route determination unit 322 determines the route based on the position information of the departure place and the destination input from the request reception unit 320 and the position information of the current location.

In step 110 (S110), the automatic driving unit 324 starts the automatic driving of the automatic vehicle 3 according to the route determined by the route determining unit 322.

In step 115 (S115), the camera control unit 326 controls the camera 308 while the automatic driving unit 324 is automatically driving the automatic vehicle 3, and photographs the surroundings of the automatic vehicle 3. The image transfer unit 328 transmits the image data taken by the camera 308, the position information of the shooting location, and the shooting time to the management server 2.

In step 120 (S120), the image receiving unit 222 of the management server 2 outputs the image data received from the image transfer unit 328, the position information of the shooting location, and the shooting time to the crime determination unit 224.

The crime determination unit 224 calculates the crime occurrence probability based on the image data received by the image reception unit 222, the position information of the shooting location, and the shooting time.

In step 125 (S125), the reporting unit 226 determines whether or not the crime occurrence probability calculated by the crime determination unit 224 is equal to or higher than the reference value; and when the crime occurrence probability is above the reference value, shifts to the processing S130, and when the crime occurrence probability is less than the reference value, shifts to the processing of S135.

In step 130 (S130), the reporting unit 226 transmits the crime occurrence probability and the location information of the shooting location to the police, the security company, and the public hall.

In step 135 (S135), the automatic driving unit 324 determines whether or not the vehicle has returned to the vicinity of the charger 4; and if the vehicle returns to the vicinity of the charger 4 (S135: Yes), the automatic driving unit completes the automatic operation and instructs the camera control unit 326 to end the shooting. The camera control unit 326 ends the shooting by the camera 308 in response to the instruction from the automatic driving unit 324.

If the automatic driving unit 324 has not returned to the vicinity of the charger 4 (S135: No), the automatic driving unit 324 returns to the process of S110 and continues the automatic operation.

As described above, according to the security system 1 of the present embodiment, the occurrence of a crime is determined based on the image taken by the autonomous vehicle 3 shared by the local residents. As a result, it is possible to automatically patrol and monitor the flow lines of local residents. Especially in depopulated areas, it is not efficient to install fixed cameras for surveillance throughout the area.

Furthermore, in such areas, public transportation tends to be in short supply, but as in this example, the means of transportation for the residents is secured by patrol monitoring with the autonomous vehicle 3 shared by the local residents. At the same time, it is possible to patrol and monitor the areas used by local residents during activity hours. Even if the number of vacant houses and abandoned cultivated land increases, it is possible to suppress unnecessary patrol monitoring of such areas.

In the above embodiment, the mode of patrol monitoring using the autonomous vehicle 3 has been described, but the autonomous vehicle 3 may be replaced with a drone and patrol monitoring may be performed by a camera built in the drone. At that time, the drone monitors while delivering the package to the residents' homes or the like by, for example, automatic driving. Further, the autonomous vehicle 3 may patrol and monitor while delivering the luggage.

In the above embodiment, the embodiment in which the autonomous vehicle 3 stands by in the vicinity of the charger 4 has been described; but the autonomous vehicle 3 may take pictures with a camera while predicting the use of the local residents based on the past usage history of the local residents, and patrolling the expected place, as in the case of a cruising taxi business.

1. An security system comprising:
a plurality of autonomous vehicles;
a camera installed in each of said plurality of autonomous vehicles; and a processor coupled to each of said plurality of autonomous vehicles and processor configured to:
determine a crime based on an image taken by the camera.

2. The security system according to claim 1, wherein
the plurality of autonomous vehicles are shared vehicles shared by residents in the area; and the processor is further configured to:
determine a crime that may occur in the area.

3. The security system according to claim 2, wherein the processor is configured to:
in response to a request from the residents, the autonomous vehicle automatically picks up at the departure point of the residents and automatically moves to the destination of the residents;
the camera take pictures of the moving section to the starting point and the moving section from the starting point to the destination; and
determine a crime based on the images taken in the moving section to the departure point and the moving section from the starting point to the destination.

4. The security system according to claim 3 further comprising:
a charger installed in a common facility in the area;
the plurality of automatic vehicles are electric vehicles, and the processor is further configured to:
charging in the vicinity of the charger, waiting until requested by the residents, and after taking the residents to their destination, returns to the vicinity of the charger;
the camera shots from the timing of departure from the vicinity of the charger to the time of returning to the vicinity of the charger, according to the request of the residents;
determine a crime based on the images taken from the vicinity of the charger to the return to the vicinity of the charger.

5. An monitoring method comprising the steps of:
moving an autonomous vehicle shared by the residents at the request of the residents;
photographing the outside of the vehicle by the camera installed in the autonomous vehicle; and
determine a crime based on the photographed image by a computer.
